(19) United States
(12) Patent Application Publication
(10) Pub. No.: US 2025/0309285 A1
(43) Pub. Date: Oct. 2, 2025

(54) MANUFACTURING METHOD AND MANUFACTURING APPARATUS OF FUEL CELL MEMBRANE ELECTRODE STRUCTURE

(71) Applicant: Honda Motor Co., Ltd., Tokyo (JP)

(72) Inventors: Toshio Mihata, Tokyo (JP); Junko Tanaka, Tokyo (JP); Kazutoshi Mameda, Tokyo (JP)

(21) Appl. No.: 19/062,018

(22) Filed: Feb. 25, 2025

(30) Foreign Application Priority Data
Mar. 28, 2024 (JP) 2024-053897

(51) Int. Cl. H01M 8/0286; H01M 8/0273; H01M 8/0284; H01M 8/248

(52) U.S. Cl. CPC H01M 8/0286; H01M 8/0273; H01M 8/248; H01M 8/0284

(57) ABSTRACT

A manufacturing method of a fuel cell membrane electrode structure configured to attach a gas diffusion layer to an assembly part in which a catalyst coated membrane having an electrode catalyst layer provided on a surface of an electrolyte membrane is supported by a resin frame member. The manufacturing method includes the steps of: placing the assembly part on a base; applying an adhesive to the assembly part placed on the base along a bonding position between the catalyst coated membrane and the resin frame member; placing the gas diffusion layer on the assembly part to which the adhesive is applied; and pressing the gas diffusion layer placed on the assembly part along the bonding position and injecting a curing accelerator to the adhesive applied to the assembly part along the bonding position through the gas diffusion layer.

### CROSS-REFERENCE TO RELATED APPLICATION

This application is based upon and claims the benefit of priority from Japanese Patent Application No. 2024-053897 filed on Mar. 28, 2024, the content of which is incorporated herein by reference.

### BACKGROUND OF THE INVENTION

### Field of the Invention

The present invention relates to a manufacturing method and a manufacturing apparatus of fuel cell membrane electrode structure.

### Description of the Related Art

In recent years, technology development on fuel cells that contribute to energy efficiency has been conducted in order for more people to be able to access affordable, reliable, sustainable, and advanced energy. As a method for manufacturing a membrane electrode structure used for this type of fuel cell, a method of bonding a resin frame member to a membrane electrode assembly (MEA) is known. For example, in the method described in JP2013-239316A, an adhesive is applied to a resin frame member placed on a heat sink and, in a state where an MEA is placed thereon, the MEA is heated and pressed while the resin frame member is cooled via the heat sink.

However, when a thermosetting adhesive is used as in JP2013-239316A, the resin frame member needs to be protected against deformation due to heat, which makes it difficult to cure the adhesive in a short period of time with a simple configuration.

### SUMMARY OF THE INVENTION

An aspect of the present invention is a manufacturing method of a fuel cell membrane electrode structure, configured to attach a gas diffusion layer to an assembly part in which a catalyst coated membrane having an electrode catalyst layer provided on a surface of an electrolyte membrane is supported by a resin frame member. The manufacturing method includes the steps of: placing the assembly part on a base; applying an adhesive to the assembly part placed on the base along a bonding position between the catalyst coated membrane and the resin frame member; placing the gas diffusion layer on the assembly part to which the adhesive is applied; and pressing the gas diffusion layer placed on the assembly part along the bonding position and injecting a curing accelerator to the adhesive applied to the assembly part along the bonding position through the gas diffusion layer.

Another aspect of the present invention is a manufacturing apparatus of a fuel cell membrane electrode structure, configured to attach a gas diffusion layer to an assembly part in which a catalyst coated membrane having an electrode catalyst layer provided on a surface of an electrolyte membrane is supported by a resin frame member. The manufacturing apparatus includes: a base on which the assembly part is placed; an application device configured to apply an adhesive to the assembly part placed on the base along a bonding position between the catalyst coated membrane and the resin frame member; and a conveyance device configured to place the gas diffusion layer on the assembly part to which the adhesive is applied. The conveyance device includes: a suction mechanism covering the gas diffusion layer; a pressing surface configured to press the gas diffusion layer placed on the assembly part along the bonding position; and an injection hole through which a curing accelerator is injected to the adhesive applied to the assembly part along the bonding position through the gas diffusion layer.

### BRIEF DESCRIPTION OF THE DRAWINGS

The objects, features, and advantages of the present invention will become clearer from the following description of embodiments in relation to the attached drawings, in which:

FIG. 1 is a perspective view schematically illustrating an overall configuration of a fuel cell stack including a fuel cell membrane electrode structure according to an embodiment of the present invention;

FIG. 2 is a cross-sectional view taken along line II-II in FIG. 1;

FIG. 3 is a front view illustrating a schematic configuration of the fuel cell membrane electrode structure in FIG. 1;

FIG. 4 is a cross-sectional view, taken along line IV-IV in FIG. 3, of the fuel cell membrane electrode structure in manufacturing process;

FIG. 5 is a cross-sectional view illustrating an example of a configuration of a main part of a manufacturing apparatus of the fuel cell membrane electrode structure according to the embodiment of the present invention;

FIG. 6 is a cross-sectional view for describing the manufacturing apparatus of the fuel cell membrane electrode structure in FIG. 5;

FIG. 7 is a front view illustrating an arrangement example of a supply hole in FIG. 6;

FIG. 8A is a front view illustrating an arrangement example of injection holes in FIG. 6;

FIG. 8B is a front view illustrating another arrangement example of the injection holes in FIG. 6;

FIG. 9 is a diagram for describing an example of a manufacturing method of the fuel cell membrane electrode structure according to the embodiment of the present invention;

FIG. 10 is a diagram illustrating a modification of FIG. 5;

FIG. 11 is a diagram illustrating a modification of FIG. 6; and

FIG. 12 is a diagram illustrating a modification of FIG. 9.

### DETAILED DESCRIPTION OF THE INVENTION

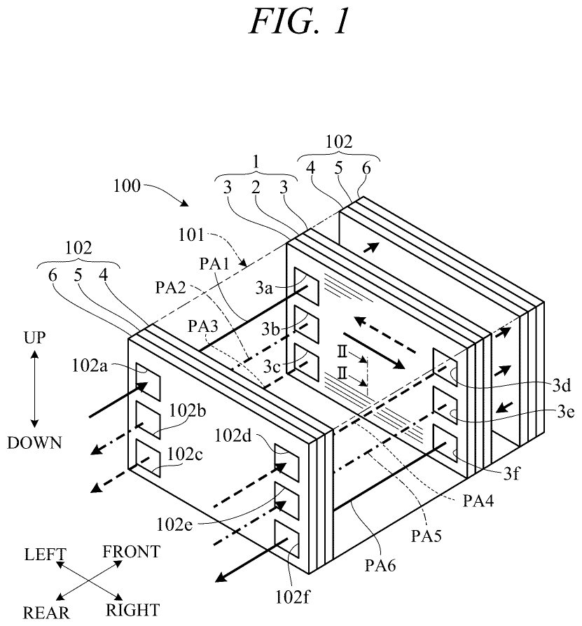

Hereinafter, an embodiment of the present invention will be described with reference to FIGS. 1 to 12. A fuel cell membrane electrode structure according to the embodiment of the present invention constitutes a power generation cell, and is included in a fuel cell stack which is a main body of a fuel cell. The fuel cell is mounted on a vehicle, for example, and generates electric power for driving the vehicle. First, an overall configuration of the fuel cell stack will be schematically described. Note that, the fuel cell stack is sometimes simply referred to as a fuel cell.

FIG. 1 is a perspective view schematically illustrating an overall configuration of a fuel cell stack 100 including the fuel cell membrane electrode structure according to the embodiment of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. These directions are not necessarily identical to a front-rear direction, a left-right direction, and an up-down direction of the vehicle. For example, the front-rear direction in FIG. 1 may be the front-rear direction, the left-right direction, or the up-down direction of the vehicle.

As illustrated in FIG. 1, the fuel cell stack 100 includes a cell laminate 101 having multiple power generation cells 1 stacked in the front-rear direction, and end units 102 arranged at both front and rear ends of the cell laminate 101, and has a substantially rectangular parallelepiped shape as a whole. A length of the cell laminate 101 in the left-right direction is longer than a length thereof in the up-down direction. In FIG. 1, a single power generation cell 1 is illustrated for the sake of convenience. The power generation cell 1 includes an electrode assembly 2 having an assembly including an electrolyte membrane and an electrode, and front and rear paired separators 3, 3 that are arranged at both front and rear sides of the electrode assembly 2 and sandwich the electrode assembly 2 therebetween. The electrode assembly 2 and the separators 3 are alternately arranged in the front-rear direction.

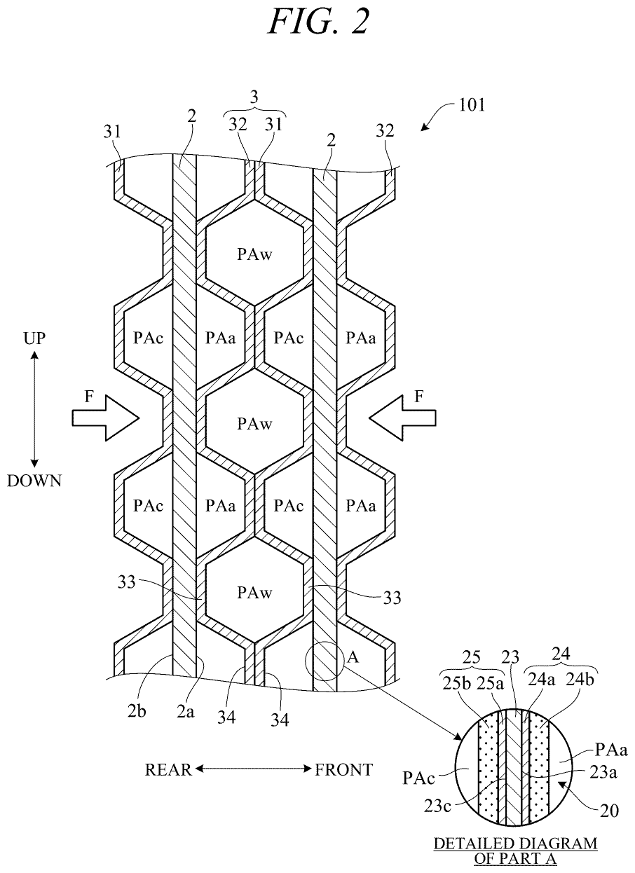

FIG. 2 is a cross-sectional view of a part of the cell laminate 101 (a cross-sectional view taken along line II-II in FIG. 1). As illustrated in FIG. 2, each separator 3 has a front plate 31 and a rear plate 32 which are a pair of front and rear metal thin plates having a corrugated cross section. The outer circumferences of the front plate 31 and the rear plate 32 are joined to each other by welding or the like, thereby forming the separator 3. For the separator 3, a conductive material having excellent corrosion resistance is used, and for example, stainless steel, titanium, a titanium alloy, or the like can be used.

A cooling flow path PAw through which a cooling medium flows is formed in the inside of the separator 3 surrounded by the front plate 31 and the rear plate 32, and a power generation surface of the power generation cell 1 is cooled by the flow of the cooling medium. For example, water can be used as the cooling medium. Surfaces (front surface and rear surface) of the separators 3 facing the electrode assembly 2 are formed in an uneven shape by press-molding or the like to form gas flow paths between the separators and the electrode assembly 2. More specifically, each separator 3 has rib portions 33 protruding toward the electrode assembly 2 and recessed portions 34 formed in a recessed shape continuously with the rib portions 33.

The rib portions 33 abut on the front surface and the rear surface of the electrode assembly 2. A compressive load F is applied to the cell laminate 101 in the front-rear direction during assembly of the fuel cell stack 100, and this compressive load F is held after the assembly of the fuel cell stack 100 is completed. Therefore, a predetermined surface pressure due to the compressive load F acts on the electrode assembly 2 in the front-rear direction via the rib portions 33.

An anode flow path PAa through which a fuel gas flows is formed by the recessed portions 34 between the front surface of the electrode assembly 2 and the rear plate 32 of the separator 3 facing this front surface. A cathode flow path PAc through which an oxidant gas flows is formed by the recessed portions 34 between the rear surface of the electrode assembly 2 and the front plate 31 of the separator 3 facing this rear surface. For example, a hydrogen gas can be used as the fuel gas, and for example, air can be used as the oxidant gas.

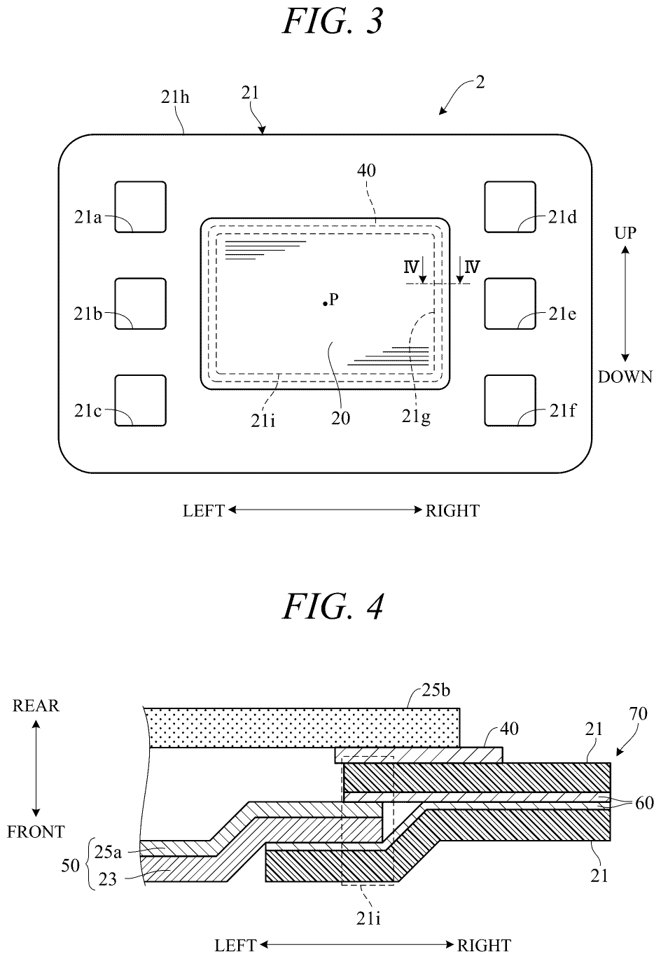

FIG. 3 is a front view illustrating a schematic configuration of the electrode assembly 2 as a membrane electrode structure (so-called a unitized electrode assembly (UEA)). As illustrated in FIG. 3, the electrode assembly 2 includes a substantially rectangular assembly 20 and a frame 21 that supports the assembly 20. The assembly 20 is a membrane electrode assembly (so-called an MEA). As illustrated in a detailed diagram of a part A in FIG. 2, the assembly 20 includes an electrolyte membrane 23, an anode electrode 24 that is provided on the front surface of the electrolyte membrane 23, and a cathode electrode 25 that is provided on the rear surface of the electrolyte membrane 23.

The electrolyte membrane 23 is, for example, a solid polymer electrolyte membrane, and a thin membrane of a perfluorosulfonic acid polymer containing moisture can be used. Not only a fluorine-based electrolyte membrane but also a hydrocarbon-based electrolyte membrane can be used.

The anode electrode 24 includes an electrode catalyst layer 24a that is provided on the front surface of the electrolyte membrane 23 and serves as an electrode reaction field, and a gas diffusion layer (GDL) 24b that is provided on the front surface of the electrode catalyst layer 24a and diffuses a fuel gas to supply the fuel gas to the electrode catalyst layer 24a. An intermediate layer (base layer) can also be provided between the electrode catalyst layer 24a and the gas diffusion layer 24b. The cathode electrode 25 includes an electrode catalyst layer 25a that is provided on the rear surface of the electrolyte membrane 23 and serves as an electrode reaction field, and a gas diffusion layer 25b that is provided on the rear surface of the electrode catalyst layer 25a and diffuses an oxidant gas to supply the oxidant gas to the electrode catalyst layer 25a. An intermediate layer (base layer) can also be provided between the electrode catalyst layer 25a and the gas diffusion layer 25b.

The electrode catalyst layers 24a, 25a include a catalytic metal that promotes an electrochemical reaction between hydrogen contained in the fuel gas and oxygen contained in the oxidant gas, an electrolyte having proton conductivity (such as ionomer), carbon particles having electron conductivity, and the like. The gas diffusion layers 24b, 25b are made of a conductive member having gas permeability, for example, a carbon porous body. The gas diffusion layers 24b, 25b contain carbon and fluorine as main components, and thus have a water repellent function.

In the anode electrode 24, the fuel gas (hydrogen) supplied through the anode flow path PAa is ionized by an action of a catalyst, passes through the electrolyte membrane 23, and moves to the cathode electrode side. Electrons generated at this time pass through an external circuit and are extracted as electric energy. In the cathode electrode 25, an oxidant gas (oxygen) supplied via the cathode flow path PAc reacts with hydrogen ions guided from the anode electrode 24 and electrons moved from the anode electrode 24 to generate water. The generated water gives an appropriate humidity to the electrolyte membrane 23, and excess water is discharged to the outside of the electrode assembly 2 along the flow of the gas.

The frame 21 in FIG. 3 is a thin plate having a substantially rectangular shape and a thickness of about 0.05 to 0.1 mm, and can be made of an insulating resin, rubber, or the like. As an example, poly ethylene naphthalate (PEN), poly phenylene sulfide (PPS), or the like can be used as a component. In particular, in the present embodiment, PPS is used as a component of the frame 21. When PEN is used in a state of being immersed in water, hydrolysis occurs, and its strength decreases with time. On the other hand, PPS has high hydrolysis resistance performance, and thus a decrease in strength with time hardly occurs.

A substantially rectangular opening 21g is provided in a central portion of the frame 21, and the assembly 20 is provided to cover the entire opening 21g. The frame 21 has a substantially rectangular outer edge portion 21h and a substantially rectangular inner edge portion 21i located inside the outer edge portion 21h. Note that, the outer edge portion 21h indicates the outer edge of the frame 21 and its peripheral portion, and the inner edge portion 21i indicates the inner edge of the frame 21 and its peripheral portion. A bonding portion 40 is provided in a frame shape around the opening 21g (inner edge portion 21i) by applying an adhesive.

A point P in FIG. 3 is a center point passing through the middle of the opening 21g in the up-down direction and the left-right direction. Three through-holes 21a to 21c penetrating the frame 21 in the front-rear direction are opened side by side in the up-down direction on the left side of the opening 21g of the frame 21, and three through-holes 21d to 21f penetrating the frame 21 in the front-rear direction are opened side by side in the up-down direction on the right side of the opening 21g.

As illustrated in FIG. 1, in the front and rear separators 3 of the electrode assembly 2, through-holes 3a to 3f penetrating the separators 3 in the front-rear direction are respectively opened at positions corresponding to the through-holes 21a to 21f of the frame 21. The through-holes 3a to 3f communicate with the through-holes 21a to 21f of the frame 21. The set of the through-holes 21a to 21f and 3a to 3f communicating with each other forms flow paths PA1 to PA6 (indicated by arrows for the sake of convenience) penetrating the cell laminate 101 and extending in the front-rear direction. The flow paths PA1 to PA6 may be referred to as manifolds. The flow paths PA1 to PA6 are connected to a manifold outside the fuel cell stack 100.

The flow path PA1 (solid arrow) extending forward via the through-holes 21a, 3a is a fuel gas supply flow path. The flow path PA6 (solid arrow) extending rearward via the through-holes 21f, 3f is a fuel gas discharge flow path. The fuel gas supply flow path PA1 and the fuel gas discharge flow path PA6 communicate with the anode flow path PAa (FIG. 2) provided to face the front surface of the assembly 20, and as indicated by the solid arrows, a fuel gas flows through the anode flow path PAa in the left-right direction via the fuel gas supply flow path PA1 and the fuel gas discharge flow path PA6. Communication between the anode flow path PAa and the other flow paths PA2 to PA5 is blocked via a seal portion (not illustrated).

The flow path PA4 (dotted arrow) extending forward via the through-holes 21d, 3d is an oxidant gas supply flow path. The flow path PA3 (dotted arrow) extending rearward via the through-holes 21c, 3c is an oxidant gas discharge flow path. The oxidant gas supply flow path PA4 and the oxidant gas discharge flow path PA3 communicate with the cathode flow path PAc (FIG. 2) provided to face the rear surface of the assembly 20, and as indicated by the dotted arrows, an oxidant gas flows through the cathode flow path PAc in the left-right direction via the oxidant gas supply flow path PA4 and the oxidant gas discharge flow path PA3. Communication between the cathode flow path PAc and the other flow paths PA1, PA2, PA5, and PA6 is blocked via a seal portion (not illustrated).

The flow path PAS (dashed-dotted line arrow) extending forward via the through-holes 21e, 3e is a cooling medium supply flow path. The flow path PA2 (dashed-dotted line arrow) extending rearward via the through-holes 21b, 3b is a cooling medium discharge flow path. The cooling medium supply flow path PAS and the cooling medium discharge flow path PA2 communicate with the cooling flow path PAw (FIG. 2) provided inside the separator 3, and a cooling medium flows through the cooling flow path PAw via the cooling medium supply flow path PAS and the cooling medium discharge flow path PA2. Communication between the cooling flow path PAw and the other flow paths PA1, PA3, PA4, and PA6 is blocked via a seal portion (not illustrated).

Each of the end units 102 arranged at both the front and rear sides of the cell laminate 101 includes a terminal plate 4, an insulating plate 5, and an end plate 6. Multiple through-holes 102a to 102f penetrating the end unit 102 in the front-rear direction are opened in the rear end unit 102. The through-hole 102a is opened on an extension line of the fuel gas supply flow path PA1 to communicate with the fuel gas supply flow path PA1. The through-hole 102b is opened on an extension line of the cooling medium discharge flow path PA2 to communicate with the cooling medium discharge flow path PA2. The through-hole 102c is opened on an extension line of the oxidant gas discharge flow path PA3 to communicate with the oxidant gas discharge flow path PA3. The through-hole 102d is opened on an extension line of the oxidant gas supply flow path PA4 to communicate with the oxidant gas supply flow path PA4. The through-hole 102e is opened on an extension line of the cooling medium supply flow path PAS to communicate with the cooling medium supply flow path PA5. The through-hole 102f is opened on an extension line of the fuel gas discharge flow path PA6 to communicate with the fuel gas discharge flow path PA6.

More specifically, a fuel gas tank storing a high-pressure fuel gas is connected to the through-hole 102a via an ejector, an injector, or the like, and the fuel gas is supplied to the fuel cell stack 100 via the through-hole 102a. The fuel gas is discharged from the through-hole 102f. A compressor for supplying an oxidant gas is connected to the through-hole 102d, and the oxidant gas compressed by the compressor is supplied to the fuel cell stack 100 via the through-hole 102d. The oxidant gas is discharged from the through-hole 102c. A pump for supplying a cooling medium is connected to the through-hole 102e, and the cooling medium is supplied to the fuel cell stack 100 via the through-hole 102e. The cooling medium is discharged from the through-hole 102b. The discharged cooling medium is cooled by heat exchange in a radiator, and is supplied to the fuel cell stack 100 again via the through-hole 102e.

The schematic configuration of the fuel cell stack 100 has been described above. Next, a manufacturing method and a manufacturing apparatus of the fuel cell membrane electrode structure according to the embodiment of the present invention will be described. FIG. 4 is a cross-sectional view, taken along line IV-IV in FIG. 3, of the electrode assembly 2 as the fuel cell membrane electrode structure in the manufacturing process, and illustrates a configuration of the frame 21 at a position at or around the right inner edge portion 21i. Note that, the configuration at or around the inner edge portion 21i is the same over the entire circumference of the inner edge portion 21i along the opening 21g. Hereinafter, the left direction in FIG. 4, that is, a direction (center side) toward the center point P in FIG. 3 may be referred to as an inner direction or an inner side, and the left side in FIG. 4 may be referred to as an inside. In addition, the right direction in FIG. 4, that is, a direction toward the outer edge portion 21h in FIG. 3 may be referred to as an outer direction or an outer side, and the right direction in FIG. 4 may be referred to as an outside.

The frame 21 is a resin frame member made of PPS, and includes a pair of front and rear frames including a front frame 21 and a rear frame 21 in the example of FIG. 4. The electrode catalyst layer 25a of the cathode electrode 25 is provided on a rear surface of the electrolyte membrane 23 by coating or the like. Hereinafter, the electrolyte membrane 23 provided with the electrode catalyst layers 24a, 25a on the surface (front surface, rear surface) thereof is referred to as a catalyst coated membrane (so-called CCM) 50.

A front surface of the catalyst coated membrane 50 is bonded to a rear surface of the inner edge portion 21i of the front frame 21 via a bonding portion 60 having an adhesive as a constituent material. A front surface of the rear frame 21 is bonded to a rear surface of the front frame 21, to which the catalyst coated membrane 50 is bonded, via the bonding portion 60. More specifically, in the inner edge portion 21i, the front surface of the rear frame 21 is bonded to the rear surface of the catalyst coated membrane 50 (electrode catalyst layer 25a), and outside the inner edge portion 21i, the front surface of the rear frame 21 is bonded to the rear surface of the front frame 21. Hereinafter, the catalyst coated membrane 50 supported by the frame 21 as a resin frame member may be referred to as an assembly part 70.

In the manufacturing method of the fuel cell membrane electrode structure according to the embodiment of the present invention, the gas diffusion layers 24b, 25b are attached to the assembly part 70 via the bonding portion 40 including an adhesive as a constituent material. Hereinafter, as an example, an example in which the gas diffusion layer 25b of the cathode electrode 25 is attached to the assembly part 70 of FIG. 4 will be described.

In a case where a moisture-curable adhesive that cures by reaction with atmospheric moisture is used for the bonding portion 40, it takes a long time to cure. In a case where a thermosetting adhesive that cures when a curing agent in resin is activated by heating is used for the bonding portion 40, the curing time can be shortened by exposure to a high temperature, but a peripheral resin member may be deformed by thermal stress. In particular, when the frame 21 is exposed to a high temperature exceeding the glass transition temperature (96° C.) of PPS as a constituent material, deformation such as warpage or undulation occurs due to thermal shrinkage, and sufficient sealing performance between the frame 21 and the separators 3 (FIG. 1) in front of and behind the frame 21 may not be secured. Meanwhile, in the case of suppressing thermal shrinkage deformation of the frame 21 by cooling by a cooler installed, the configuration of the entire apparatus becomes complicated.

In the case of using, for the bonding portion 40, an ultraviolet-curable adhesive that polymerizes and cures when inside molecules are activated by irradiation with ultraviolet light, the adhesive can be cured in a short time and at a relatively low temperature, but it is difficult to apply the adhesive in a case where the bonding portion 40 is covered with a member that does not transmit ultraviolet light. More specifically, when the bonding portion 40 is sandwiched between members that do not transmit ultraviolet light (the frame 21 and the gas diffusion layer 25b in the example of FIG. 4), it is difficult to apply the ultraviolet-curable adhesive.

Therefore, in the present embodiment, the manufacturing method and the manufacturing apparatus of the fuel cell membrane electrode structure are configured as follows so as to cure an adhesive in a short time with a simple configuration by using a curing accelerator.

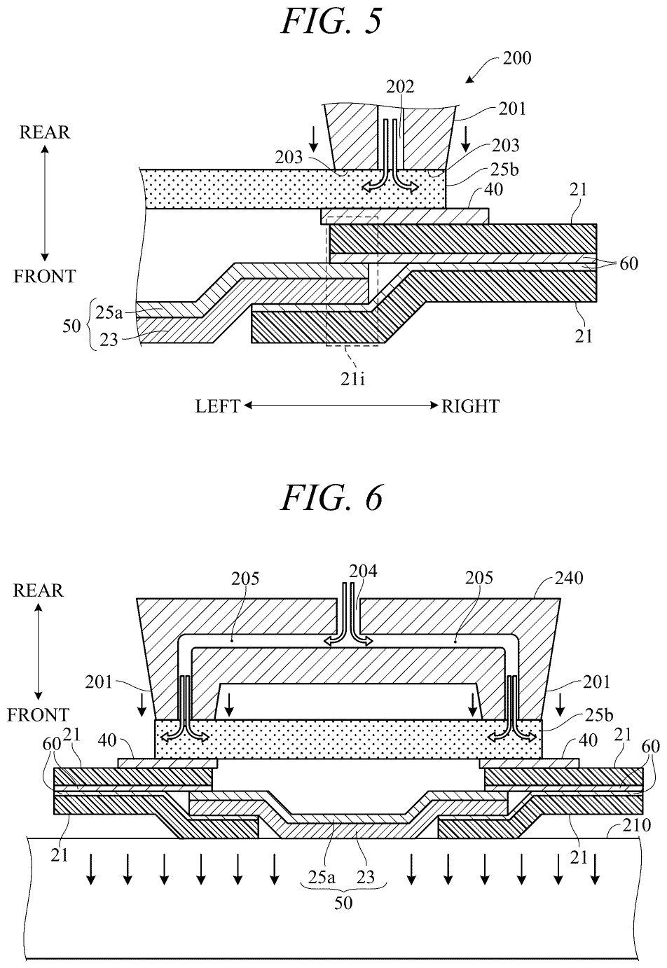

FIG. 5 is a cross-sectional view illustrating an example of a configuration of a main part of a manufacturing apparatus (hereinafter, apparatus) 200 of the fuel cell membrane electrode structure according to the embodiment of the present invention, and illustrates a state in which a curing accelerator is injected to the bonding portion 40 in FIG. 4 by the apparatus 200. In the example of FIG. 5, the apparatus 200 includes a nozzle shaped injection unit 201 that injects a curing accelerator, and injects an appropriate curing accelerator through an injection hole 202 drilled in the injection unit 201. For example, when an instantaneous adhesive mainly composed of 2-cyanoacrylate, which is a moisture-curable adhesive, is used for the bonding portion 40, an amine-based compound can be used as a curing accelerator. The curing accelerator is a gas. As illustrated in FIG. 5, the curing accelerator injected into the gas diffusion layer 25b through the injection hole 202 passes through the gas diffusion layer 25b and reaches the bonding portion 40 to accelerate curing of the adhesive.

The tip (front surface) of the injection unit 201 is formed as a pressing surface 203 in which the periphery of the injection hole 202 is flat, and presses the rear surface of the gas diffusion layer 25b. The pressing surface 203 of the injection unit 201 presses the gas diffusion layer 25b to bring the gas diffusion layer 25b and the assembly part 70 into pressure contact with each other while the curing accelerator is injected to the bonding portion 40 through the injection hole 202, whereby the gas diffusion layer 25b can be reliably attached to the assembly part 70 in a short time. In addition, by locally pressing the periphery of the bonding portion 40 by the pressing surface 203 around the injection hole 202, the curing accelerator can be concentrated on the bonding portion 40 and efficiently cured.

FIG. 6 is a cross-sectional view for describing the apparatus 200 in FIG. 5. As illustrated in FIG. 6, the apparatus 200 includes a base 210 on which the assembly part 70 is placed, an application device 220 (not illustrated) that applies an adhesive to the assembly part 70 placed on the base 210, a conveyance device 230 (not illustrated) that conveys the gas diffusion layer 25b and places it on the assembly part 70 to which the adhesive is applied, and an injection device 240 that sprays a curing accelerator to the adhesive (bonding portion 40).

The base 210 has a suction mechanism, and is configured as, for example, a belt conveyor. Multiple holes are uniformly provided on the entire placement surface of the base 210 and, by sucking the air through the holes by a vacuum pump, the placed member (assembly part 70) can be sucked (suction mechanism). Such a suction mechanism is provided in a wider range than the assembly part 70 (front surface) so as to be able to uniformly suck the entire assembly part 70 to be placed. The components of electrode assembly 2 including the assembly part 70 and the gas diffusion layer 25b are each very thin (for example, the electrolyte membrane is about 15 μm, and the gas diffusion layer is about 110 to 130 μm) and soft. By uniformly sucking the entire placement surface by the suction mechanism, deflection and deformation of each member can be suppressed.

The application device 220 is configured as a discharge gun provided in a robot arm, and applies an adhesive to the assembly part 70 placed on the base 210 along the inner edge portion 21i (FIGS. 3 and 4) which is a bonding position between the catalyst coated membrane 50 and the frame 21. Once the assembly part 70 is placed on the base 210, the application device 220 is lowered by the robot arm toward the assembly part 70 placed on the base 210, and applies an adhesive (bonding portion 40) to the assembly part 70 (frame 21) along the inner edge portion 21i. Once the adhesive is applied to the assembly part 70, the application device 220 is retracted by the robot arm.

The conveyance device 230 includes a suction mechanism and is provided in the robot arm (not illustrated). The suction mechanism of the conveyance device 230 is provided in a wider range than the gas diffusion layer 25b (rear surface) so as to be able to uniformly suck the entire gas diffusion layer 25b to be conveyed, and covers the gas diffusion layer 25b. Once the application device 220 retracts, the conveyance device 230 is lowered by the robot arm toward the assembly part 70, to which the bonding portion 40 is applied, in a state where the gas diffusion layer 25b is sucked by the suction mechanism, and places the gas diffusion layer 25b on the assembly part 70 (bonding portion 40). Once the gas diffusion layer 25b is placed on the assembly part 70, the conveyance device 230 stops suction of the gas diffusion layer 25b by the suction mechanism, and is retracted by the robot arm.

The injection device 240 includes the injection unit 201 of FIG. 5 and is provided in the robot arm (not illustrated). The injection device 240 is also provided with a supply hole 204 through which a curing accelerator is supplied from a dispenser (not illustrated) or the like, and a flow path 205 that connects the supply hole 204 and the injection hole 202. The injection device 240 (front surface) is configured to have substantially the same shape as the gas diffusion layer 25b (rear surface) and covers the gas diffusion layer 25b so as to be able to inject the curing accelerator at a time along the inner edge portion 21i. By injecting the curing accelerator at a time through the supply hole 204, the flow path 205, and the injection hole 202, the curing accelerator can be uniformly injected along the inner edge portion 21i.

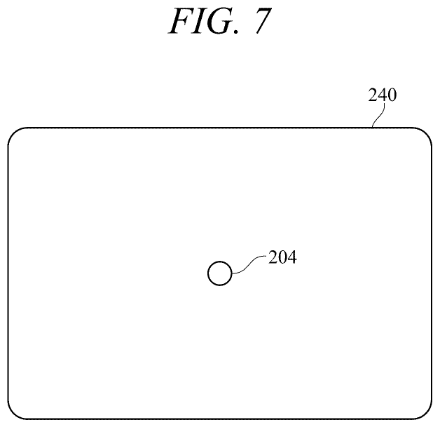

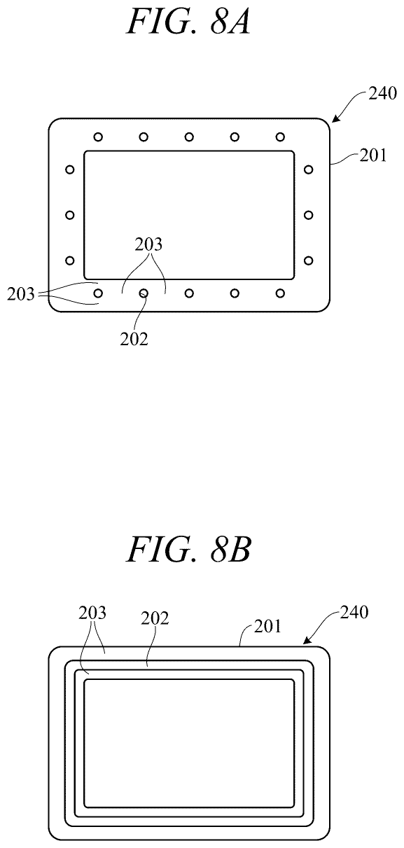

FIG. 7 is a front view illustrating an arrangement example of the supply hole 204, and FIGS. 8A and 8B are front views illustrating an arrangement example of the injection hole 202. As illustrated in FIG. 7, the supply hole 204 is drilled in the center of the rear surface of the injection device 240, for example. As illustrated in FIGS. 8A and 8B, the injection hole 202 is drilled along the inner edge portion 21i (FIGS. 3 and 4). In the example of FIG. 8A, multiple circular injection holes 202 are formed at equal intervals. In the example of FIG. 8B, a continuous groove-shaped injection hole 202 is formed. The shape and arrangement of the supply hole 204 are not limited to those illustrated, and may be provided, for example, at a position other than the center of the rear surface of the injection device 240. Further, multiple supply holes 204 may be provided. The shape and arrangement of the injection hole 202 are also not limited to those illustrated, and for example, multiple groove-shaped injection holes 202 may be provided.

Once the conveyance device 230 retracts, the injection device 240 is lowered by the robot arm toward the gas diffusion layer 25b placed on the assembly part 70 (bonding portion 40). As illustrated in FIGS. 5 and 6, when the injection device 240 descends, the pressing surface 203 of the injection unit 201 presses the gas diffusion layer 25b along the inner edge portion 21i, and injects the curing accelerator to the bonding portion 40 via the injection hole 202 and the gas diffusion layer 25b. As a result, the adhesive (bonding portion 40) is quickly cured.

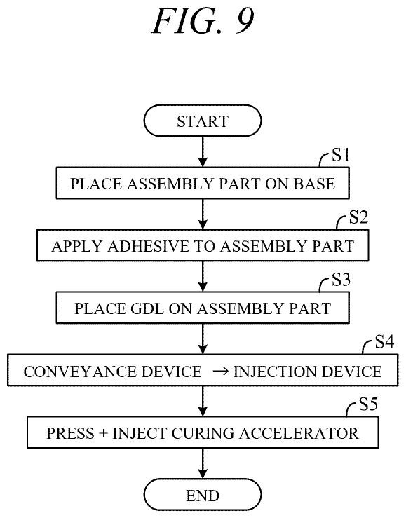

FIG. 9 is a diagram for describing an example of a manufacturing method of the fuel cell membrane electrode structure according to the embodiment of the present invention. As illustrated in FIG. 9, first, the assembly part 70 is placed on the base 210 in S1 (S: step). Next, in S2, an adhesive (bonding portion 40) is applied to the assembly part 70 placed on the base 210 along the inner edge portion 21i by the application device 220. Next, in S3, the gas diffusion layer 25b is conveyed by the conveyance device 230, and the gas diffusion layer 25b is placed on the assembly part 70 (bonding portion 40) placed on the base 210. Next, in S4, the conveyance device 230 is retracted, and the injection device 240 is lowered toward the gas diffusion layer 25b placed on the assembly part 70 (bonding portion 40). Next, in S5, the injection device 240 presses the gas diffusion layer 25b placed on the assembly part 70 (bonding portion 40) along the inner edge portion 21i, and injects the curing accelerator to the bonding portion 40 along the inner edge portion 21i via the gas diffusion layer 25b. Once S5 is completed, the injection device 240 is retracted.

As described above, the injection device 240 presses the gas diffusion layer 25b placed on the bonding portion 40, and injects the curing accelerator to the bonding portion 40 via the gas diffusion layer 25b, so that the adhesive (bonding portion 40) can be reliably cured in a short time with a simple configuration. In the process of manufacturing the electrode assembly 2, as illustrated in FIGS. 4 to 6, after the gas diffusion layer 25b of the cathode electrode 25 is attached to the assembly part 70, the member of the anode electrode 24 is further attached. For example, catalyst coated diffusion media (so-called CCDM) in which the electrode catalyst layer 24a is provided on the surface of the gas diffusion layer 24b of the anode electrode 24 is attached. In this case, after the assembly part 70 to which the gas diffusion layer 25b of the cathode electrode 25 is attached in S1 to S5 is reversed on, for example, the base 210, the process proceeds to the step of attaching the catalyst coated diffusion media. By reliably curing the adhesive (bonding portion 40) in a short time in S5, it is possible to reduce the time required to manufacture the electrode assembly 2 and to suppress deflection and deformation of each member, displacement between members, and the like at the time of reversal.

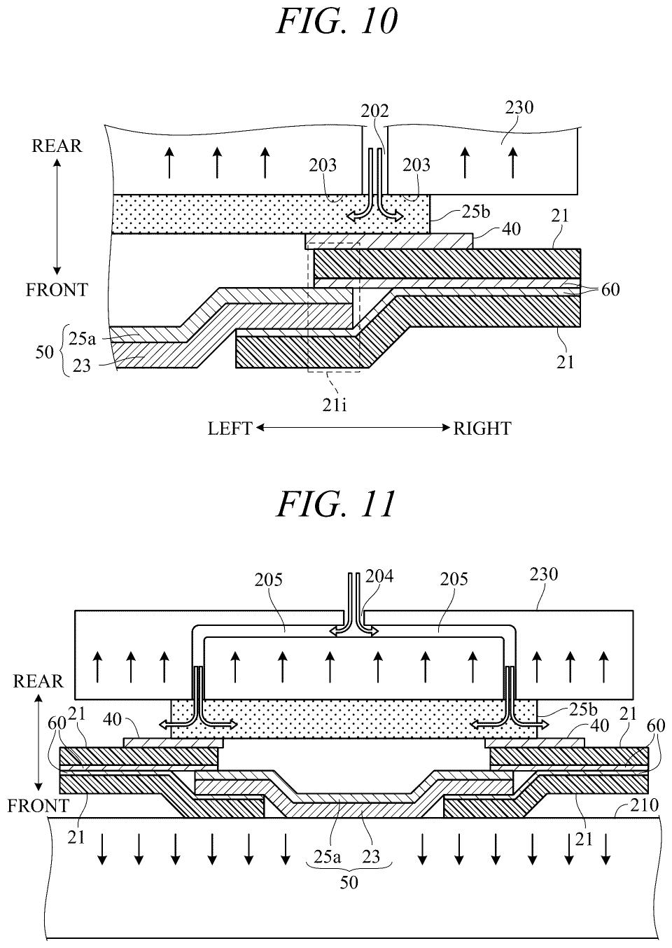

The apparatus 200 may have a configuration in which the injection hole 202, the pressing surface 203, the supply hole 204, and the flow path 205 of the injection device 240 are provided in the conveyance device 230. FIGS. 10, 11, and 12 are diagrams respectively illustrating modifications of FIGS. 5, 6, and 9 in a case where the injection hole 202, the pressing surface 203, the supply hole 204, and the flow path 205 are provided in the conveyance device 230.

In the examples of FIGS. 10 and 11, the injection hole 202 is drilled in the suction surface (front surface) of the conveyance device 230, and the suction surface around the injection hole 202 constitutes the pressing surface 203. Further, the suction mechanism of the conveyance device 230 is provided in a wider range than the assembly part 70 (frame 21) (rear surface) so that the entire assembly part 70 to which the gas diffusion layer 25b is attached can be uniformly sucked and conveyed, and covers the assembly part 70.

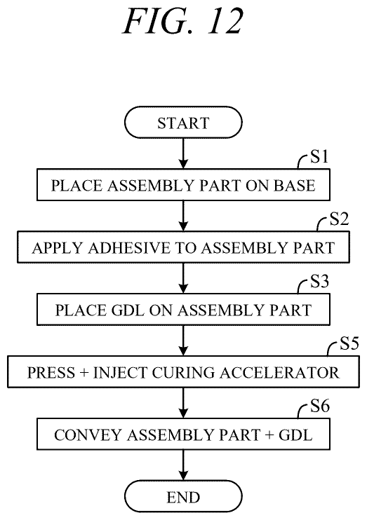

In the example of FIG. 12, after the gas diffusion layer 25b is placed on the assembly part 70 placed on the base 210 by the conveyance device 230 in S3, the process proceeds to S5 without retracting the conveyance device 230. Then, in S5, the conveyance device 230 presses the gas diffusion layer 25b placed on the assembly part 70, and injects a curing accelerator to the bonding portion 40. Further, once S5 is completed, the process directly proceeds to S6 without retracting the conveyance device 230, and the assembly part 70 to which the gas diffusion layer 25b is attached is sucked by the suction mechanism of the conveyance device 230 and transported to the next process by the robot arm.

As described above, by providing the injection hole 202 and the pressing surface 203 in the conveyance device 230 having the suction mechanism, it is not necessary to replace the conveyance device 230 and the injection device 240, and the time required to manufacture the electrode assembly 2 can be further reduced. In addition, by securing the suction surface of the conveyance device 230 so that the assembly part 70 to which the gas diffusion layer 25b is attached can be conveyed, it is possible to reduce the time required to convey the assembly part 70 to which the gas diffusion layer 25b is attached after the bonding portion 40 is cured.

According to the present embodiment, the following operations and effects can be achieved.

(1) In the manufacturing method of the fuel cell membrane electrode structure, the gas diffusion layer 25b is attached to the assembly part 70 in which the catalyst coated membrane 50 having the electrode catalyst layer 25a provided on the surface of the electrolyte membrane 23 is supported by the frame 21 (FIG. 4). The manufacturing method of the fuel cell membrane electrode structure includes: step S1 of placing the assembly part 70 on the base 210; step S2 of applying an adhesive to the assembly part 70, placed on the base 210, along the inner edge portion 21i that is a bonding position between the catalyst coated membrane 50 and the frame 21; step S3 of placing the gas diffusion layer 25b on the assembly part 70 to which the adhesive is applied; and step S5 of pressing the gas diffusion layer 25b, placed on the assembly part 70, along the inner edge portion 21i and injecting a curing accelerator to the bonding portion 40, which is the adhesive applied to the assembly part 70, along the inner edge portion 21i via the gas diffusion layer 25b (FIGS. 9 and 12).

As described above, by pressing the gas diffusion layer 25b placed on the bonding portion 40 and injecting the curing accelerator to the bonding portion 40 via the gas diffusion layer 25b, the adhesive (bonding portion 40) can be cured in a short time with a simple configuration. In addition, by reliably curing the adhesive (bonding portion 40) in a short time, it is possible to reduce the time required to manufacture the electrode assembly 2 and to suppress deflection and deformation of each member, displacement between members, and the like at the time of conveyance or reversal.

(2) In the apparatus 200, the gas diffusion layer 25b is attached to the assembly part 70 in which the catalyst coated membrane 50 having the electrode catalyst layer 25a provided on the surface of the electrolyte membrane 23 is supported by the frame 21 (FIG. 4). The apparatus 200 includes: the base 210 on which the assembly part 70 is placed; the application device 220 that applies an adhesive to the assembly part 70, placed on the base 210, along the inner edge portion 21i that is a bonding position between the catalyst coated membrane 50 and the frame 21; and the conveyance device 230 that places the gas diffusion layer 25b on the assembly part 70 to which the adhesive is applied (FIGS. 6 and 11). The conveyance device 230 includes: the suction mechanism that covers the gas diffusion layer 25b; the pressing surface 203 that presses the gas diffusion layer 25b, placed on the assembly part 70, along the inner edge portion 21i; and the injection hole 202 through which to inject a curing accelerator to the bonding portion 40, which is the adhesive applied to the assembly part 70, along the inner edge portion 21i via the gas diffusion layer 25b (FIG. 11).

As described above, by pressing the gas diffusion layer 25b placed on the bonding portion 40 and injecting the curing accelerator to the bonding portion 40 via the gas diffusion layer 25b, the adhesive (bonding portion 40) can be cured in a short time with a simple configuration. In addition, by reliably curing the adhesive (bonding portion 40) in a short time, it is possible to reduce the time required to manufacture the electrode assembly 2 and to suppress deflection and deformation of each member, displacement between members, and the like at the time of conveyance or reversal. Further, by providing the injection hole 202 and the pressing surface 203 in the conveyance device 230 having the suction mechanism, it is not necessary to replace the conveyance device 230 and the injection device 240, and the time required to manufacture the electrode assembly 2 can be further reduced.

(3) The suction mechanism of the conveyance device 230 further covers the assembly part 70 (FIG. 11). The conveyance device 230 further conveys the assembly part 70 to which the gas diffusion layer 25b is attached. As described above, by securing the suction surface of the conveyance device 230 so that the assembly part 70 to which the gas diffusion layer 25b is attached can be conveyed, it is possible to reduce the time required to convey the assembly part 70 to which the gas diffusion layer 25b is attached after the bonding portion 40 is cured.

(4) The conveyance device 230 has the multiple injection holes 202 along the inner edge portion 21i (FIG. 8A). By providing the injection hole 202 along the inner edge portion 21i, the curing accelerator can be efficiently injected to the adhesive (bonding portion 40) applied along the inner edge portion 21i. In addition, by locally pressing the periphery of the bonding portion 40 by the pressing surface 203 around the injection hole 202, the curing accelerator can be concentrated on the bonding portion 40 and efficiently cured.

(5) The conveyance device 230 further includes: the supply hole 204 through which to supply the curing accelerator; and the flow path 205 that connects the supply hole 204 and the multiple injection holes 202 (FIGS. 6 and 11). As a result, the curing accelerator can be injected at a time through the supply hole 204, the flow path 205, and the injection hole 202, and the curing accelerator can be uniformly injected along the inner edge portion 21i, so that the bonding portion 40 can be cured more efficiently.

In the above embodiment, the specific configurations and arrangements of the assembly part 70 and the gas diffusion layer 25b, and the example of the process of manufacturing the electrode assembly 2 including them have been described with reference to FIG. 4 and the like. However, the manufacturing method and manufacturing apparatus of the fuel cell membrane electrode structure in which the gas diffusion layer is attached to the assembly part in which the catalyst coated membrane having the electrode catalyst layer provided on the surface of the electrolyte membrane is supported by the resin frame member are not limited to those exemplified. For example, the present invention may be applied to a case where the gas diffusion layer 24b of the anode electrode 24 is attached as the gas diffusion layer, or may be applied to a case where the gas diffusion layer 24b of the anode electrode 24 and the gas diffusion layer 25b of the cathode electrode 25 are attached as the gas diffusion layer at the same time. The assembly part may include only the single frame 21, for example.

The above embodiment can be combined as desired with one or more of the aforesaid modifications. The modifications can also be combined with one another.

According to the present invention, it becomes possible to cure the adhesive in a short time with a simple configuration.

Above, while the present invention has been described with reference to the preferred embodiments thereof, it will be understood, by those skilled in the art, that various changes and modifications may be made thereto without departing from the scope of the appended claims.

1. A manufacturing method of a fuel cell membrane electrode structure, configured to attach a gas diffusion layer to an assembly part in which a catalyst coated membrane having an electrode catalyst layer provided on a surface of an electrolyte membrane is supported by a resin frame member, comprising the steps of:
placing the assembly part on a base;
applying an adhesive to the assembly part placed on the base along a bonding position between the catalyst coated membrane and the resin frame member;
placing the gas diffusion layer on the assembly part to which the adhesive is applied; and
pressing the gas diffusion layer placed on the assembly part along the bonding position and injecting a curing accelerator to the adhesive applied to the assembly part along the bonding position through the gas diffusion layer.

2. A manufacturing apparatus of a fuel cell membrane electrode structure, configured to attach a gas diffusion layer to an assembly part in which a catalyst coated membrane having an electrode catalyst layer provided on a surface of an electrolyte membrane is supported by a resin frame member, comprising:
a base on which the assembly part is placed;
an application device configured to apply an adhesive to the assembly part placed on the base along a bonding position between the catalyst coated membrane and the resin frame member; and
a conveyance device configured to place the gas diffusion layer on the assembly part to which the adhesive is applied, wherein
the conveyance device includes:
a suction mechanism covering the gas diffusion layer;
a pressing surface configured to press the gas diffusion layer placed on the assembly part along the bonding position; and
an injection hole through which a curing accelerator is injected to the adhesive applied to the assembly part along the bonding position through the gas diffusion layer.

3. The manufacturing apparatus according to claim 2, wherein
the suction mechanism further covers the assembly part, wherein
the conveyance device further conveys the assembly part to which the gas diffusion layer is attached.

4. The manufacturing apparatus according to claim 2, wherein
the conveyance device includes a plurality of the injection holes along the bonding position.

5. The manufacturing apparatus according to claim 4, wherein
the conveyance device further includes:
a supply hole through which the curing accelerator is supplied; and
a flow path connecting the supply hole and the plurality of injection holes.

6. The manufacturing apparatus according to claim 2, wherein
the suction mechanism includes a vacuum pump, wherein
a plurality of holes are uniformly provided on the pressing surface, wherein
the gas diffusion layer is sucked by sucking air through the plurality of holes by the vacuum pump.
